(19) United States
(12) Patent Application Publication
(10) Pub. No.: US 2021/0256624 A1
(43) Pub. Date: Aug. 19, 2021

(54) RESOURCE CONSUMPTION RATE AND CONSUMPTION LEVEL CONTROL SYSTEM

(71) Applicant: Tiller LLC, Winthrop, WA (US)

(72) Inventors: Peter Polson, Seattle, WA (US); Randy Hulett, Seattle, WA (US); Brasten Sager, Kirkland, WA (US)

(73) Assignee: Tiller LLC, Winthrop, WA (US)

(21) Appl. No.: 17/246,505

(22) Filed: Apr. 30, 2021

Related U.S. Application Data
(63) Continuation-in-part of application No. 15/144,538, filed on May 2, 2016, now abandoned.
Application No. 15/144,538 is a continuation of application No. 14/741,394, filed on Jun. 16, 2015, now abandoned.
(60) Provisional application No. 62/012,606, filed on Jun. 16, 2014.

(51) Int. Cl. G06Q 40/00

(52) U.S. Cl. CPC G06Q 40/12

(57) ABSTRACT

A multi-modal process for tracking and controlling resource consumption in configured categories utilizes one or more of a one-to-one bulk allocation matching algorithm, complex bulk allocation matching algorithm, and a bulk allocation offsets algorithm, based on the consistency and resolution of inputs from and intermediary resource provider and banking resource system.

### CROSS-REFERENCE TO RELATED APPLICATIONS

This application claims priority and benefit as a continuation-in-part of U.S. application Ser. No. 15/144,538, filed on May 2, 2016. Application Ser. No. 15/144,538 claims priority and benefit as a continuation of U.S. application Ser. No. 14/741,394, filed on Jun. 16, 2015. Application Ser. No. 14/741,394 claims priority and benefit under 35 U.S.C. 119 to U.S. application Ser. No. 62/012,606, filed on Jun. 16, 2014. The contents of each of these applications are incorporated herein by reference in their entirety.

### BACKGROUND

Intelligent resource management enables planning for consumption and expenditures, identifies waste, aligns priorities, and assists in making process improvements in supply chains, manufacturing, operations, and so on. A component of efficient resource management is tracking, alerting, and controlling consumption rates and levels in particular resource categories. Due to inefficiencies in upstream resource provider systems, it is often challenging to accurately track and control resource consumption.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B depict a resource exchange system 100 in accordance with one embodiment.

FIG. 2 depicts an algorithm 200 in accordance with one embodiment.

FIG. 3A and FIG. 3B depict another algorithm 300 in accordance with one embodiment.

FIG. 4 depicts yet another algorithm 400 in accordance with one embodiment.

FIG. 5 depicts a resource control process 500 utilizing results of the algorithm 200 and algorithm 300 in one embodiment.

FIG. 6 depicts a diagrammatic representation of a machine 600 in the form of a computer system within which a set of instructions may be executed for causing the machine to perform any one or more of the methodologies discussed herein, according to an example embodiment.

FIG. 7 depicts a client server network configuration 700 for implementing aspects of the disclosed methodologies in accordance with one embodiment.

### DETAILED DESCRIPTION

Systems and processes are disclosed to enable tracking and control over outbound resource allocation and consumption rates and levels in networked environments having implicit operational limitations and inefficiencies due to the structure of the procurement systems they interact with. One source of such inefficiencies is the database structure of certain procurement systems. In particular, in some cases a resource allocation/consumption may be tracked in a first database, a shipment allocation for the resource tracked in a second, separate database, and the clustering of these allocations may be inefficiently organized such that rate and level controls become challenging to implement accurately and efficiently.

Certain terms in the following disclosure should be understood as follows:

“Line item” refers to a record identifying an order for a particularly identified resource.

“Order” refers to a transaction including one or more line items.

“Bulk allocation” refers to an aggregation of allocations for one or more line items. A single order may result in one or more bulk allocation(s).

“Line item disambiguation” refers to disambiguating a bulk allocation into one or more discrete line items whose allocations contributed to the bulk allocation.

A line item disambiguation algorithm disambiguates a bulk allocation into discrete line-item/resource-level detail for categorization, control, and alerts. For example, a single procured allocation may comprise a first resource, a second resource, and a third resource. Splitting the procured allocation into discrete line items enables granular categorical tracking and control over resource flows, and consumption rates and target levels.

By way of example, a line item disambiguation algorithm may transform a transaction comprising a bulk allocation from this state:

| | | Exchanged | |
|---|---|---|---|
| Date | Description | Allocation | Category |
| Dec. 4, 2020 | Intermed Us*m031h6bj1, | −182.54 | ??? |
| | Intermed.com/billwa | | |

to this state:

| Date | Description | Exchanged Allocation | Category |
|---|---|---|---|
| Dec. 4, 2020 | Resource 1 | −25.00 | 1 |
| Dec. 4, 2020 | Resource 2 | −30.00 | 4 |
| Dec. 4, 2020 | Resource 3 | −127.54 | 11 |

At a high level of generality, a tracking and control system 102 that compensates for the inefficiencies described previously in the operation of an intermediary resource provider 104 may execute categorization logic to map line-item transaction detail to a transaction log (a dynamic database of transaction records), such that the line items may be categorized at a granular level. The tracking and control system 102 may then remove or neutralize bulk allocations. In other words, line item totals are likely already accounted for in the transaction log as a bulk allocation. Thus, the bulk allocations are replaced or removed.

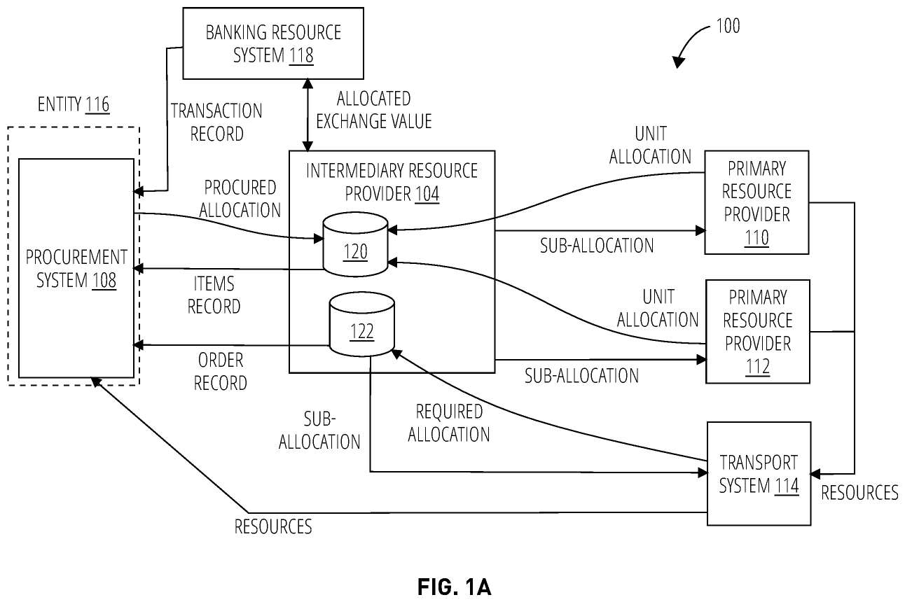

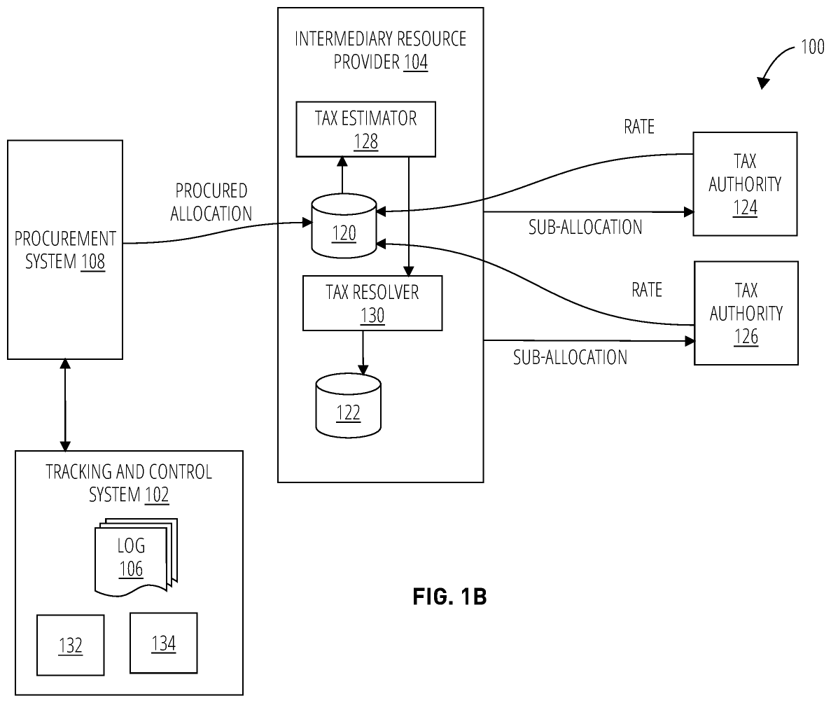

A portion of an exemplary algorithm and logic structure for mapping and categorizing line-item details in a transaction log is provided below. The algorithm is implemented in JSON and utilizes an approach that defines column mappings from a line-item data source (e.g., the items record in FIG. 1A) to the corresponding columns in the transaction log. The algorithm may be readily extended with additional JSON entries in manners well known and understood in the art.

The mapping/categorizing algorithm may utilize templates (e.g., programmatic row- and column-associative tables) comprising multi-field formulaic mapping in some cases. An example of such a mapping rule is one that sums the “Unit Allocation” and “Tax Allocation” columns in a table, multiplies by “Quantity” column, adds the “Shipping Allocation” column, and reverses the polarity before mapping the resultant allocation to the “Amount” column in the transaction log:

“Amount”: “=−1*(‘Quantity’*(‘Unit Allocation’+‘Tax Allocation’)+‘Shipping Allocation’)”

Another type of rule that may be utilized by the mapping algorithm is a multi-field concatenated rule (see ‘uniqueID’ elsewhere herein), such as the following example that concatenates the “OrderID” and “ReversalID” columns into a static text parameter and then maps the resultant string into the “Full Description” column:

“Full Description”: “[Itermed Refund Item] ‘OrderID’ (Reversal ID: ‘ReversalID’)”

A variety of algorithms may be utilized to disambiguate bulk allocations generated by the intermediary resource provider 104. For example, one or a combination of the following general algorithms may be utilized:

1. One-to-one bulk allocation matching

2. Complex bulk allocation matching

3. Bulk allocation offsets

In one-to-one bulk allocation matching algorithms, the input data set contains data comprises one or more fields that provide a high-confidence match between line items and a bulk allocation in the transaction log 106. For example, the algorithm may establish a match by:
A bulk allocation “order” record with matching date, amount and vendor name.
A number of line items whose individual allocations exactly total a bulk allocation within an appropriate temporal matching window (that is configurable per input provider) of the line items.

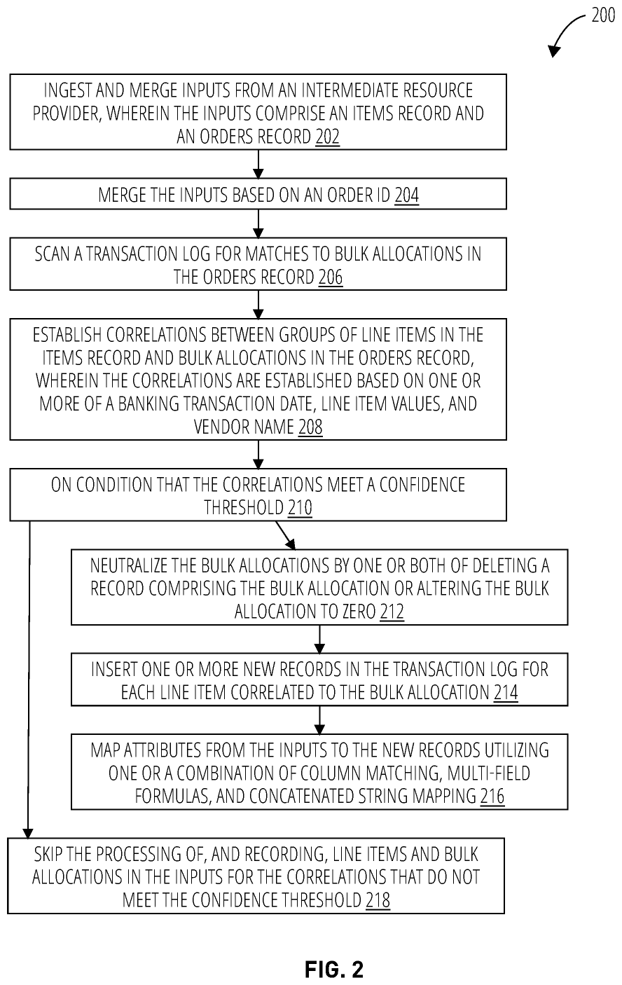

One-to-one bulk allocation matching may be advantageous because, when there is a high confidence bulk allocation match detected, the bulk allocation match may be deleted or overwritten with the line item allocations from the input sources. This reduces the amount of additional records in the transaction log 106 (e.g. versus solutions like transaction offsets) and thus reduces machine storage resources consumed in the tracking and control system 102 and/or procurement system 108 over other approaches. It also may substantially improve algorithm efficiency by removing correction factors from the transaction log 106 that complicate the algorithms and potentially make them less accurate. The record count and number of correction factors in the transaction log 106, may impose constraints on algorithm and system performance especially when there are a great many resource procurement transactions to analyze. An exemplary one-to-one bulk matching algorithm is provided in FIG. 2.

Not all intermediary resource provider 104 may provide system inputs with sufficient resolution to perform one-to-one bulk allocation matching. In some cases a complex bulk allocation matching algorithm may be utilized with inputs from such sources, for example where inputs from the intermediary resource provider 104 do not enable direct 1:1 correlation between orders (or order totals) and bulk allocations. An original order for a procured allocation may be split into multiple orders as line items of the original order become ready for shipment, and the bulk allocations may be likewise componentized.

A complex bulk allocation matching algorithm may utilize iterative or factorial analysis to determine which bulk allocation(s) in the transaction log correlate to each order. A correlation may be established when a set of bulk allocations collectively meet one or more conditions. For example, an order recorded on the date Dec. 4, 2021 for five line items may be represented by two bulk allocations with the following attributes:
bulk allocation record dates are within three days of the order date
bulk allocations sum to the total allocation for the five line item allocations
bulk allocation descriptions comprise the same vendor descriptor

Multiple correlation criteria, similar to those utilized for one-to-one bulk allocation correlation, may be utilized, such as ranges, formulas, combinations of fields, string regex criteria, and so on.

Complex bulk allocation matching tends to consume more processor/computational bandwidth than one-to-one correlation algorithms and is speculative and inaccurate to some degree. As with one-to-one algorithms, confidence thresholds may be configured on the correlations to mitigate these constraints. Complex bulk allocation matching may however reduce the amount of additional records in the transaction log 106 over other approaches such as transaction offset algorithms.

An exemplary transformation of records in the transaction log 106 for a single order, utilizing complex bulk allocation correlation, is depicted below:

From this state:

| | | Exchanged | |
|---|---|---|---|
| Date | Description | Allocation | Category |
| Dec. 5, 2020 | Intermed Us*m031h6xk2, | −76.15 | ??? |
| | Intm.com/billwa | | |
| Dec. 4, 2020 | Intermed Us*m031h6bj1, | −182.54 | ??? |
| | Intm.com/billwa | | |

To this state:

| Date | Description | Exchanged Allocation | Category |
|---|---|---|---|
| Dec. 5, 2020 | Resource 1 | −25.00 | 1 |
| Dec. 5, 2020 | Resource 2 | −30.00 | 3 |
| Dec. 4, 2020 | Resource 3 | −127.54 | 11 |
| Dec. 4, 2020 | Resource 4 | −59.93 | 11 |
| Dec. 4, 2020 | Resource 5 | −12.22 | 8 |

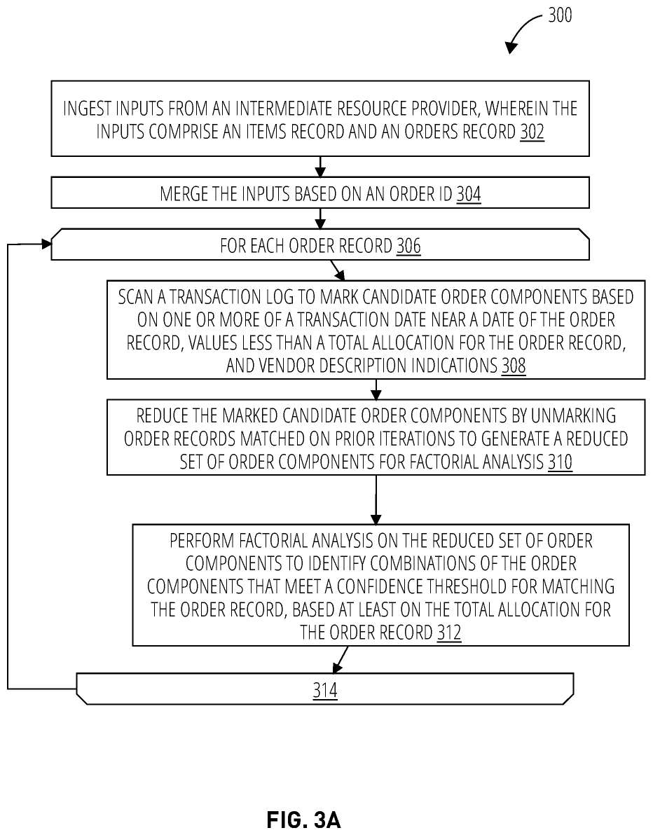

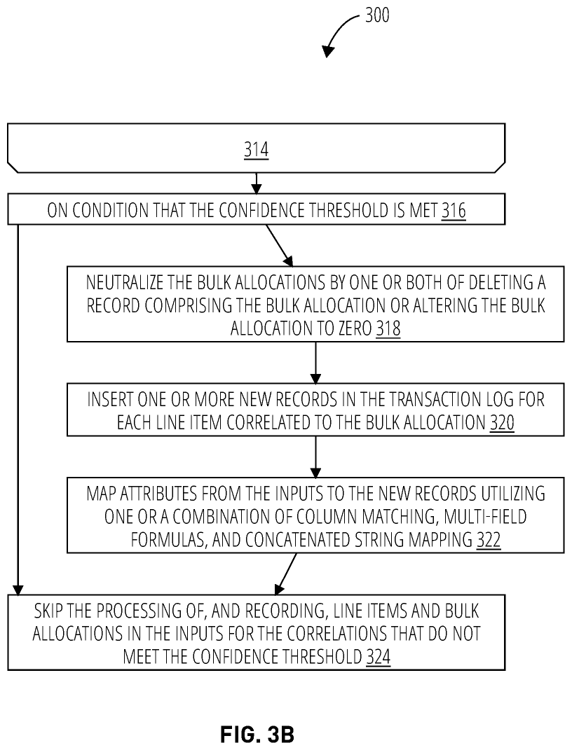

An exemplary algorithm for complex bulk allocation matching is depicted in FIG. 3A and FIG. 3B. A factorialization algorithm example that may be utilized with complex bulk allocation matching is described below. The algorithm generates all kk-subsets of a given array. A kk-subset of set XX is a partition of all the elements in XX into kk non-empty subsets. Thus, for {1, 2, 3, 4} a 3-subset is {{1,2}, {3}, {4}}.

```
import copy
arr = [1,2,3,4]
def t(k,accum,index):
  print accum,k
  if index = = len(arr):
    if(k= =0):
      return accum;
    else:
      return [ ];
  element = arr[index];
  result = [ ]
  for set_i in range(len(accum) ):
    if k>0:
      clone_new = copy.deepcopy(accum);
      clone_new[set_i].append([element]);
      result.extend( t(k-1,clone_new,index+1) );
    for elem_i in range(len(accum[set_i])):
      clone_new = copy.deepcopy(accum);
      clone_new[set_i][elem_i].append(element)
      result.extend( t(k,clone_new,index+1) );
  return result
print t(3,[ [ ] ],0);
```

When integrity issues with the inputs prevent high confidence matching between an order and one (or more) bulk allocations in the transaction log using either one-to-one or complex correlation algorithms, a transaction offsets algorithm may provide a low-computational complexity workaround.

Transaction offsets algorithms do not search the transaction log 106 for one or more matches to the bulk allocation. Rather than finding the (one or more) matches to the bulk allocation in the transaction log and neutralizing it, the transaction offsets algorithm adds new allocation record(s) directed to neutralizing the bulk allocation (wherever it is in the transaction log 106). An unmatched bulk allocation is neutralized by creating a new bulk allocation with the opposite polarity. If an actual bulk allocation and the corresponding transaction offset are categorized the same, the allocations cancel, leaving the new line-item allocations remaining in the transaction log 106 for categorization.

An exemplary application of the transaction offset algorithm transforms transaction log records from this state (for two orders):

| | | Exchanged | |
|---|---|---|---|
| Date | Description | Allocation | Category |
| Dec. 5, 2020 | Intermed Us*m031h6xk2, | −76.15 | ??? |
| | Intm.com/billwa | | |
| Dec. 4, 2020 | Intermed Us*m031h6bj1, | −182.54 | ??? |
| | Intm.com/billwa | | |

to this state:

| | | Exchanged | |
|---|---|---|---|
| Date | Description | Allocation | Category |
| Dec. 5, 2020 | Resource 1 | −25.00 | 1 |
| Dec. 5, 2020 | Resource 2 | −30.00 | 3 |
| Dec. 5, 2020 | Intermed Us*m031h6xk2, | −76.15 | Transfer |
| | Intm.com/billwa | | |
| Dec. 4, 2020 | Intermed Us*m031h6bj1, | −182.54 | Transfer |
| | Intm.com/billwa | | |
| Dec. 5, 2020 | Order Offset | 75.00 | Transfer |
| | (Order #11-200-2330) | | |
| Dec. 4, 2020 | Order Offset | 180.00 | Transfer |
| | (Order #11-201-4355) | | |
| Dec. 4, 2020 | Resource 3 | −127.54 | 11 |
| Dec. 4, 2020 | Resource 4 | −59.93 | 11 |
| Dec. 4, 2020 | Resource 5 | −12.22 | 8 |

The records added to the transaction log 106 by the transaction offsets algorithm are categorized as “Transfer”. The “Transfer” category roughly nets to null leaving the line item entries to replace the resource tracking impact of the original bulk allocations.

One downside to this approach is a larger transaction log 106 that, rather than just including the five line item transactions, also includes additional, non-resource flow affecting records for the bulk allocations and the offsets. Another downside is that due to the input integrity issue that prevents high-confidence matching (a determination of which may cause the system to roll-over to executing a transaction offsets algorithm), there are often small discrepancies between the calculated order allocations and the actual bulk allocations (one such is evident in the example above). These discrepancies are created by incomplete data (e.g. missing tax allocations, shipping allocations, fees, discounts, etc.) or preliminary estimates (e.g. estimated tax allocation, estimated shipping allocation, etc.) that differ from final allocations. The end result of the discrepancies is that the “Transfer” allocations may not cancel out and may accrue residual effects on resource tracking and rate control.

In some cases the line item transaction inputs may be obtained out-of-band from the signaling between the procurement system 108 and the intermediary resource provider 104. For example line item information about a resource procurement may be gleaned from status emails from primary resource providers or intermediary resource providers, in some implementations. These emails may be structure to comprise fields—transaction date, unit allocation, tax allocations, resource description, quantity, shipping tracking number, etc.—to correlate line item details with orders. Functionality to analyze email for field values is well known and understood in the art.

In some embodiments a special column (e.g., “meta”) may be implemented in the transactions transaction log 106 structure as a catchall for order information that doesn't categorize into the other transactions log columns (in a stringified JSON format). For example:

{“providername”:{“id”:“114-0343864-0277029”,“quantity”:4,“item-allocation”:12.34,“account”:“noreply@stanfordalumni.org”,“total”:54.36,“shipDate”:“03/16/20 21”,“tracking”:“INTERMED_US(TBA198629502104)”,“isbn”:“B01LX43HWH”,“unspsc”:“101 90000”,“provider”:“Stock Your Business”,“category-hint”:“FUEL”,“banking-resource-instrument”: “Visa—5419”,“type”:“purchase allocation”}}

An order id may be sufficient in some cases to correlate new line items queued for import and prevent a duplicated import operation. However, more granular line-item level correlation is generally desirable. The meta/concatenated field may comprise unique identifiers at the line-item level, beyond the order level). Unique rules for this meta field based for each input type. For example, for one source of line item inputs, the unique id may be constructed by a concatenation rule:

“uniqueId”: [“id”, “isbn”, “quantity”, “tracking” ]

When the concatenated field order ID, ISBN #, quantity and shipping tracking number is compared on subsequent orders, a strong correlation or exact match means the line item should not be reimported. This approach provides robust protection against split shipments, duplicate line items, and reordered resources.

FIG. 1A and FIG. 1B depict a resource exchange system 100 in one embodiment. A procurement system 108 procures an allocation of resources from an intermediary resource provider 104, which acts as an intermediary for a plurality of primary resource providers 110, 112 and for a transport system 114 to move the procured resources from the primary resource providers 110, 112 to an entity 116 that operates the procurement system 108. Here the term ‘primary resource provider’ should be understood to mean any provider of the resource upstream (closer to the manufacturer of the resource) from the intermediary resource provider 104, and not necessarily the manufacturer of the resource.

In exchange for the procured allocation the intermediary resource provider 104 initiates one or more transactions with a banking resource system 118 engaged by the entity 116, generating one or more transaction records for the exchange.

A procured allocation is submitted from the procurement system 108 in exchange for resource items identified in an items database 120 of the intermediary resource provider 104. In response the intermediary resource provider 104 generates and communicates to the procurement system 108 an items record documenting the procured allocation. The items database 120 comprises identifiers of resource items that may be procured in association with unit allocations for those items assigned by the individual primary resource providers 110, 112. The unit allocations indicate how much of the procured allocation should be associated with each primary resource provider for each item. Each primary resource provider receives a sub-allocation of the allocated exchange allocation based on the contributed unit allocations to the procured allocation.

The intermediary resource provider 104 engages the transport system 114 to move the procured allocation to the entity 116, in exchange for providing the transport system 114 a sub-allocation of the allocated exchange allocation. The sub-allocation provided to the transport system 114 corresponds to a required allocation provided by the transport system 114 to the order database 122 to move the resource items to the entity 116.

A further complication is introduced due to the sub-allocation of a portion of the allocated exchange allocation to one or more tax authorities (tax authority 124, tax authority 126). Each tax authority may provide a tax rate or amount to items defined in the items database 120, and receive a proportional sub-allocation of the allocated exchange allocation. The intermediary resource provider 104 may utilize a tax estimator 128 algorithm to generate an estimated amount of the allocated exchange allocation to allocate to taxes. This amount may appear on the items record. However, a tax resolver 130 may later determine different allocation(s) that may appear on the order record. These different allocations may each span only a subset of the overall order in some cases. Likewise, the sub-allocation for shipping may be comprised in a total allocated exchange allocation in the order record but may not be comprised in the total allocated exchange allocation appearing in the items record.

Although not depicted, resource sub-allocations may also be configured for resources returned to the primary resource providers or intermediary resource provider 104, for promotions of certain resources, refunds on certain resources, reversals, and tax exemptions. See the exemplary mapping algorithm above for examples.

The transaction record generated by the banking resource system 118 typically includes only the allocated exchange allocation for the procured allocation. The inconsistencies between the total exchange allocations indicated on the items record and order record may generate downstream inefficiencies and inaccuracies in a category-based tracking and control system 102 that utilizes the transaction records from the banking resource system 118 to track and control rates and thresholds of banking resource allocation and utilization for configured time periods.

Yet another complication arises when portions of the procured allocation are shipped under different tracking codes, and/or on different dates. The transaction record from the banking resource system 118 typically does not include tracking numbers, nor per-item exchange allocation allocations. Further the allocated exchange allocation for the procured allocation may be recorded as multiple distinct transactions in the transaction record.

Yet another complication arises due to unpredictability of the clustering algorithm utilized by the intermediary resource provider 104 to group items in the procured allocation into orders. For example when the procurement allocation specifies ten items, the intermediary resource provider 104 may cluster these into one, two, three, or more orders.

Due to these inconsistencies between item, order, and transaction records, and the unpredictability of the upstream clustering algorithm, it may become challenging for the tracking and control system 102 to correlate particular items to portions of the allocated exchange allocation. The tracking and control system 102 may therefore benefit from being adapted to account for these inconsistencies and inefficiencies in the upstream intermediary resource provider 104 and banking resource system 118.

The tracking and control system 102 may be configured with resource rate/consumption controls 132 and resource level controls 134. These controls may be compared against determined total category allocations for consumption rate consumption and/or levels generated by application of algorithms to the various inputs from the intermediary resource provider 104 and banking resource system 118. Alerts, gates, and other limits may then be generated/applied by the procurement system 108 on rates/levels of resource consumption for configured categories of resources based on these allocations.

FIG. 2 depicts an algorithm 200 in one embodiment. In block 202, the algorithm 200 ingests and merges inputs from an intermediate resource provider, wherein the inputs comprise an items record and an orders record. In block 204, the algorithm 200 merges the inputs based on an order id. In block 206, the algorithm 200 scans a transaction log for matches to bulk allocations in the orders record. In block 208, the algorithm 200 establishes correlations between groups of line items in the items record and bulk allocations in the orders record, wherein the correlations are established based on one or more of a banking transaction date, line item allocations, and vendor name. On condition that the correlations meet a confidence threshold (block 210), the algorithm 200 neutralizes the bulk allocations by one or both of deleting a record comprising the bulk allocation or altering the bulk allocation to zero at block 212, inserts one or more new records in the transaction log for each line item correlated to the bulk allocation at block 214, and maps attributes from the inputs to the new records utilizing one or a combination of column matching, multi-field formulas, and concatenated string mapping at block 216. The algorithm 200 skips the processing of, and recording of, line items and bulk allocations in the inputs for the correlations to not meet the confidence threshold (block 218).

FIG. 3A and FIG. 3B depict another algorithm 300 in one embodiment. In block 302, the algorithm 300 ingests and merges inputs from an intermediate resource provider, wherein the data sources comprise an items record and an orders record. In block 304, the algorithm 300 merges the inputs based on an order id. For each order record (opening loop block 306), the algorithm 300 scans a transaction log to mark candidate order components based on one or more of a transaction date near a date of the order record, allocations less than a total allocation for the order record, and vendor description indications (block 308), reduces the marked candidate order components by unmarking order records matched on prior iterations to generate a reduced set of order components for factorial analysis (block 310), and performs factorial analysis on the reduced set of order components to identify combinations of the order components that meet a confidence threshold for matching the order record, based at least on the total allocation for the order record (closing loop block 312).

After the algorithm 300 proceeds past closing loop block 314, and on condition that the confidence threshold is met (316), the algorithm 300 neutralizes the bulk allocations by one or both of deleting a record comprising the bulk allocation or altering the bulk allocation to zero (block 318), inserts one or more new records in the transaction log for each line item correlated to the bulk allocation (block 320), and maps attributes from the inputs to the new records utilizing one or a combination of column matching, multi-field formulas, and concatenated string mapping (block 322). In block 324, the algorithm 300 skips the processing of, and recording of, line items and bulk allocations in the inputs for the correlations to not meet the confidence threshold.

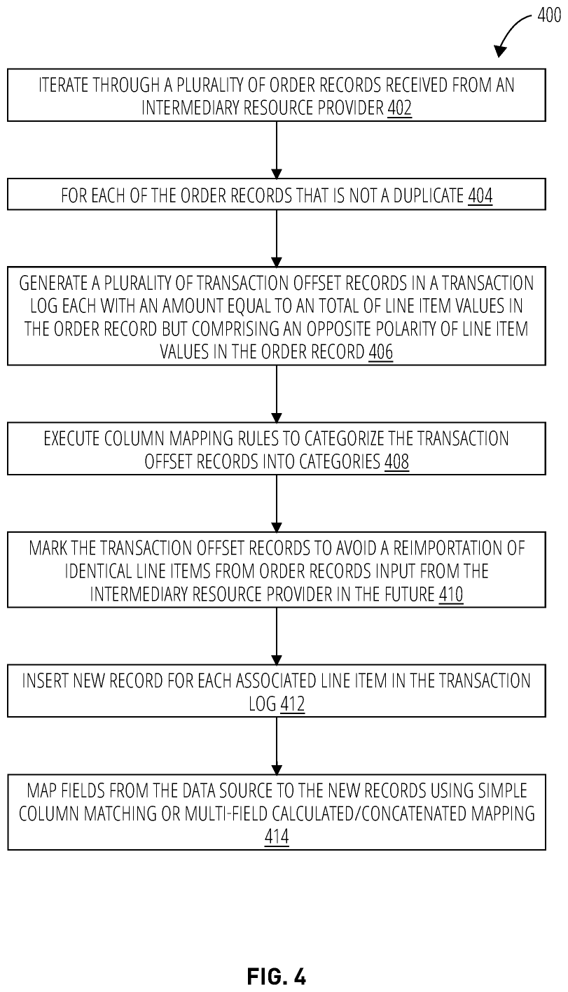

FIG. 4 depicts another algorithm 400 in one embodiment. At block 402 the algorithm 400 iterates through a plurality of order records received from an intermediary resource provider. For each of the order records that is not a duplicate (block 404), the algorithm 400 generates a plurality of transaction offset records in a transaction log each with an amount equal to a total of line item allocations in the order record but comprising an opposite polarity of line item allocations in the order record (block 406), executes column mapping rules to categorize the transaction offset records into categories (block 408), marks the transaction offset records to avoid a reimportation of identical line items from order records input from the intermediary resource provider in the future (block 410), inserts a new record in the transaction log for each of the line item allocations in the order record (block 412), and maps fields from the data source to the new rows using one or more of simple column matching, multi-field calculated matching, and concatenated string mapping (block 414). The aggregate records in the transaction log may then be categorized into total allocations and alerts and controls generated and implemented on procurement levels and consumption rates based on comparisons of the categorized total allocations with configured rates and levels of the resources.

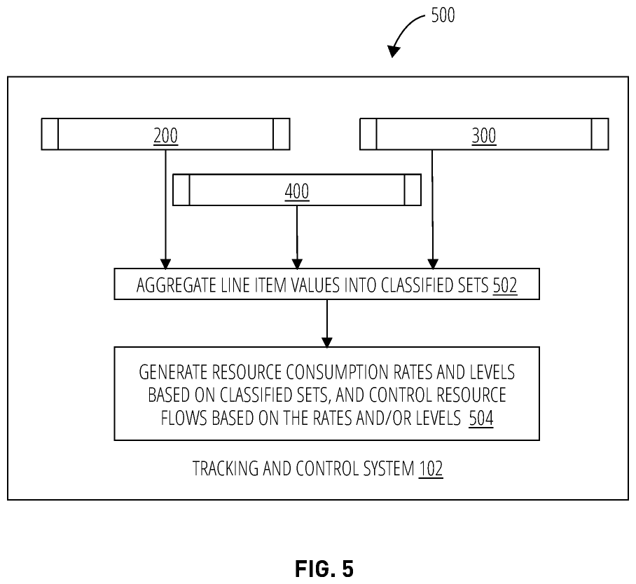

FIG. 5 depicts a resource control process 500 utilized in the tracking and control system 102 in one embodiment. The resource control process 500 is multimodal, and utilizes results of one or more of the algorithm 200, algorithm 300, algorithm 400. In block 502, the line item allocations from the algorithm 200 and/or algorithm 300 are aggregated into classified sets. In block 504, resource consumption rates and levels are generated based on these classified sets, and resource flows are controlled based on the rates and/or levels.

The multi-modal resource control process 500 may select from among a one-to-one bulk allocation matching algorithm 200, complex bulk allocation matching algorithm 300, a bulk allocation offsets algorithm 400, based on machine resource constraints (e.g., level of computational utilization or efficiency, file sizes) and/or the consistency and resolution of inputs from the intermediary resource provider 104 and banking resource system 118. For example:

```
receive inputs from particular combination of providers
execute algorithm 200
line item disambiguation threshold met?
  YES: categorize and control rates and thresholds; configure
system to automatically utilize algorithm 200 with particular
combination of providers
  NO: execute algorithm 400
line item disambiguation threshold met?
  YES: categorize and control rates and thresholds; configure
system to automatically utilize algorithm 400 with particular
combination of providers
  NO: execute algorithm 300; configure system to automatically
utilize algorithm 300 with particular combination of providers
```

The resource exchange system 100 may thus evaluate inputs from a combination of one or more resource providers and one or more banking resource providers by applying a one-to-one bulk allocation matching algorithm, a bulk allocation offsets algorithm, and a complex bulk allocation matching algorithm in a specific execution sequence (which may vary from the sequence in the example above). On condition that one of the bulk allocation algorithm outputs results that meet a configured accuracy constraint, the resource exchange system 100 may terminate the execution sequence, generate alerts on and controls of one or more of the consumption rates and levels based on the results and further based on configured desired rates and levels of the resources (e.g., as previously described), and may configure the computing system to utilize by default, on future inputs from the combination of resource providers, the one of the bulk allocation algorithm that output results that met the configured accuracy constraint.

### Machine Embodiments

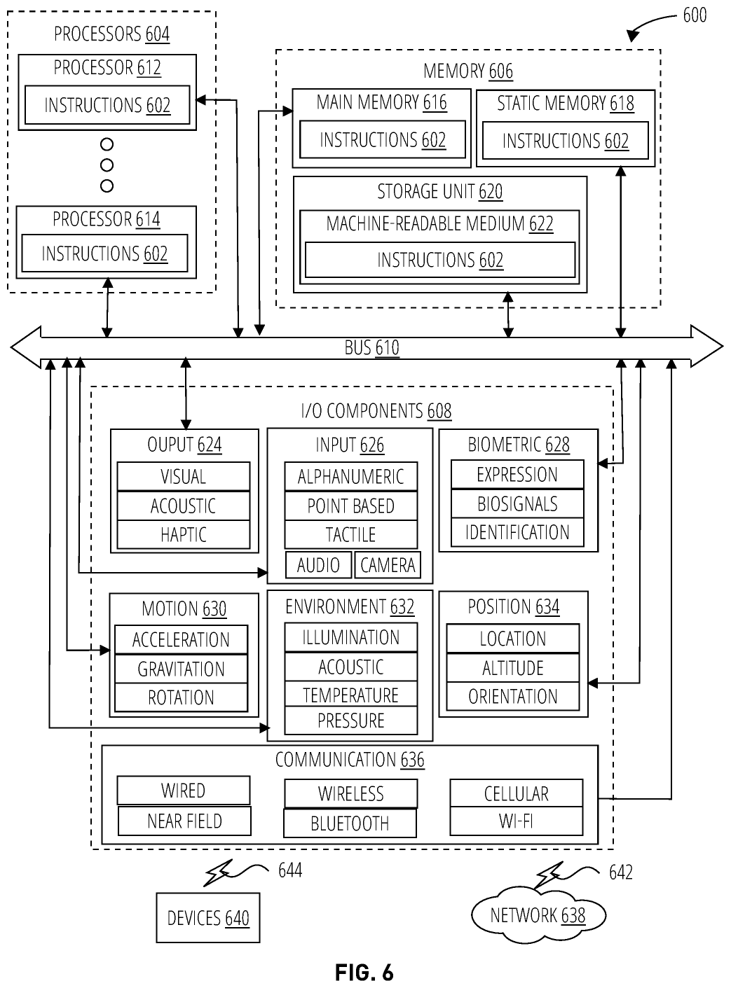

FIG. 6 depicts a diagrammatic representation of a machine 600 in the form of a computer system within which logic may be implemented to cause the machine to perform any one or more of the functions or methods disclosed herein, according to an example embodiment.

Specifically, FIG. 6 depicts a machine 600 comprising instructions 602 (e.g., a program, an application, an applet, an app, or other executable code) for causing the machine 600 to perform any one or more of the functions or methods discussed herein. For example the instructions 602 may configure the machine 600 to implement one or more of the methodologies herein, such as algorithm 200, algorithm 300, and algorithm 400. The instructions 602 configure a general, non-programmed machine into a particular machine 600 programmed to carry out embodiments of the disclosed algorithms.

In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while only a single machine 600 is depicted, the term “machine” shall also be taken to include a collection of machines that individually or jointly execute the instructions 602 to perform any one or more of the methodologies or subsets thereof discussed herein.

The machine 600 may include processors 604, memory 606, and I/O components 608, which may be configured to communicate with each other such as via one or more bus 610. In an example embodiment, the processors 604 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 612 and processor 614) to execute the instructions 602. The term “processor” is intended to include multi-core processors that may comprise two or more independent processors (sometimes referred to as “cores”) that may execute instructions contemporaneously. Although FIG. 6 depicts multiple processors 604, the machine 600 may include a single processor with a single core, a single processor with multiple cores (e.g., a multi-core processor), multiple processors with a single core, multiple processors with multiples cores, or any combination thereof.

The memory 606 may include one or more of a main memory 616, a static memory 618, and a storage unit 620, each accessible to the processors 604 such as via the bus 610. The main memory 616, the static memory 618, and storage unit 620 may be utilized, individually or in combination, to store the instructions 602 embodying any one or more of the functionality described herein. The instructions 602 may reside, completely or partially, within the main memory 616, within the static memory 618, within a machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones will likely include a touch input device or other such input mechanisms, while a headless server machine will likely not include such a touch input device. It will be appreciated that the I/O components 608 may include many other components that are not shown in FIG. 6. The I/O components 608 are grouped according to functionality merely for simplifying the following discussion and the grouping is in no way limiting. In various example embodiments, the I/O components 608 may include output components 624 and input components 626. The output components 624 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 608 may include biometric components 628, motion components 630, environmental components 632, or position components 634, among a wide array of possibilities. For example, the biometric components 628 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 630 may include acceleration sensor components (e.g., accelerometer), gravitation sensor components, rotation sensor components (e.g., gyroscope), and so forth. The environmental components 632 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 634 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 608 may include communication components 636 operable to couple the machine 600 to a network 638 or devices 640 via a coupling 642 and a coupling 644, respectively. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

### Instruction and Data Storage Medium Embodiments

The various memories (i.e., memory 606, main memory 616, static memory 618, and/or memory of the processors 604) and/or storage unit 620 may store one or more sets of instructions and data structures (e.g., software) embodying or utilized by any one or more of the methodologies or functions described herein. These instructions (e.g., the instructions 602), when executed by processors 604, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

Some aspects of the described subject matter may in some embodiments be implemented as computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular data structures in memory. The subject matter of this application may be practiced in a variety of system configurations, including hand-held devices, consumer electronics, general-purpose computers, more specialty computing devices, etc. The subject matter may also be practiced in distributed computing environments where tasks are performed by remote-processing devices that are linked through a communications network.

### Communication Network Embodiments

In various example embodiments, one or more portions of the network 638 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 638 or a portion of the network 638 may include a wireless or cellular network, and the coupling 642 may be a Code Division Multiple Access (CDMA) connection, a Global System for Mobile communications (GSM) connection, or another type of cellular or wireless coupling. In this example, the coupling 642 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 602 and/or data generated by or received and processed by the instructions 602 may be transmitted or received over the network 638 using a transmission medium via a network interface device (e.g., a network interface component included in the communication components 636) and utilizing any one of a number of well-known transfer protocols (e.g., hypertext transfer protocol (HTTP)). Similarly, the instructions 602 may be transmitted or received using a transmission medium via the coupling 644 (e.g., a peer-to-peer coupling) to the devices 640. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 602 for execution by the machine 600, and/or data generated by execution of the instructions 602, and/or data to be operated on during execution of the instructions 602, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Software Implementations

The systems disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However the system need not necessarily be accessed over a network and could, in some embodiments, be implemented by one or more app or applications on a single device or distributed between a mobile device and a computer, for example.

In another particular embodiment, the bulk allocation matching algorithms previously described are implemented as software.

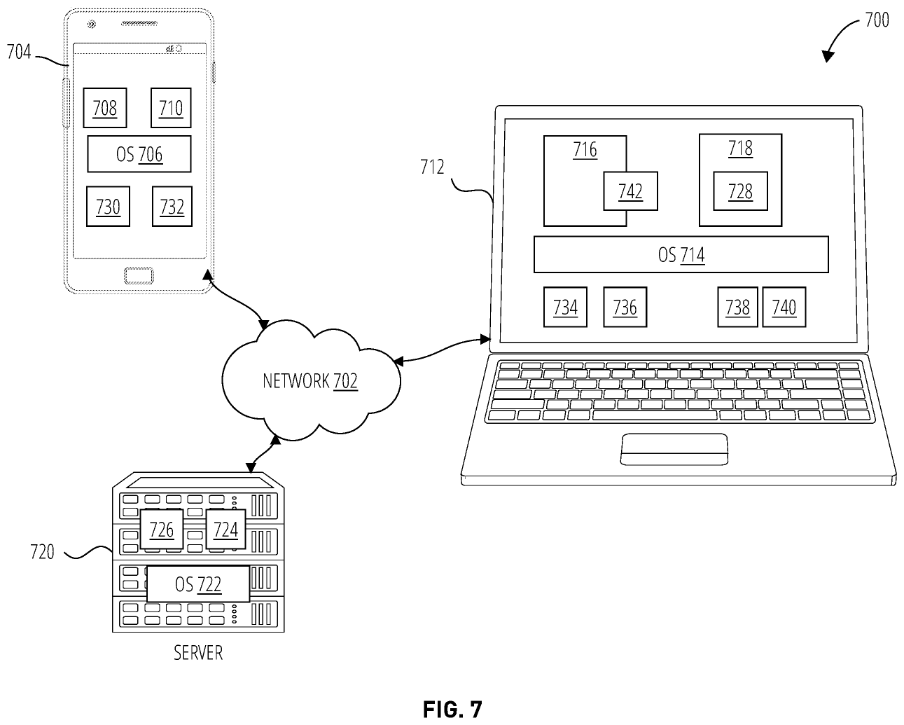

Referring to FIG. 7, a client server network configuration 700 depicts various computer hardware devices and software modules coupled by a network 702 in one embodiment. Each device includes a native operating system, typically pre-installed on its non-volatile RAM, and a variety of software applications or apps for performing various functions.

The mobile programmable device 704 comprises a native operating system 706 and various apps (e.g., app 708 and app 710). A computer 712 also includes an operating system 714 that may include one or more library of native routines to run executable software on that device. The computer 712 also includes various executable applications (e.g., application 716 and application 718). The mobile programmable device 704 and computer 712 are configured as clients on the network 702. A server 720 is also provided and includes an operating system 722 with native routines specific to providing a service (e.g., service 724 and service 726) available to the networked clients in this configuration.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

A compiler is typically used to transform source code into object code and thereafter a linker combines object code files into an executable application, recognized by those skilled in the art as an “executable”. The distinct file comprising the executable would then be available for use by the computer 712, mobile programmable device 704, and/or server 720. Any of these devices may employ a loader to place the executable and any associated library in memory for execution. The operating system executes the program by passing control to the loaded program code, creating a task or process. An alternate means of executing an application or app involves the use of an interpreter (e.g., interpreter 728).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 730 or driver 732 on the mobile programmable device 704 or computer 712 (e.g., driver 734 and driver 736) might enable wireless headphones to be used for audio output(s) and a camera to be used for video inputs. Any of the devices may read and write data from and to files (e.g., file 738 or file 740) and applications or apps may utilize one or more plug-in (e.g., plug-in 742) to extend their capabilities (e.g., to encode or decode video files).

The network 702 in the client server network configuration 700 can be of a type understood by those skilled in the art, including a Local Area Network (LAN), Wide Area Network (WAN), Transmission Communication Protocol/Internet Protocol (TCP/IP) network, and so forth. These protocols used by the network 702 dictate the mechanisms by which data is exchanged between devices.

“Algorithm” refers to any set of instructions configured to cause a machine to carry out a particular function or process.

“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported.

“Compiled computer code” refers to object code or executable code derived by executing a source code compiler and/or subsequent tools such as a linker or loader.

“Compiler” refers to logic that transforms source code from a high-level programming language into object code or in some cases, into executable code.

“Computer code” refers to any of source code, object code, or executable code.

“Computer code section” refers to one or more instructions.

“Computer program” refers to another term for ‘application’ or ‘app’.

“Driver” refers to low-level logic, typically software, that controls components of a device. Drivers often control the interface between an operating system or application and input/output components or peripherals of a device, for example.

“Executable” refers to a file comprising executable code. If the executable code is not interpreted computer code, a loader is typically used to load the executable for execution by a programmable device.

“Executable code” refers to instructions in a ready-to-execute form by a programmable device. For example, source code instructions in non-interpreted execution environments are not executable code because they must usually first undergo compilation, linking, and loading by the operating system before they have the proper form for execution. Interpreted computer code may be considered executable code because it can be directly applied to a programmable device (an interpreter) for execution, even though the interpreter itself may further transform the interpreted computer code into machine language instructions.

“File” refers to a unitary package for storing, retrieving, and communicating data and/or instructions. A file is distinguished from other types of packaging by having associated management metadata utilized by the operating system to identify, characterize, and access the file.

“Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Interpreted computer code” refers to instructions in a form suitable for execution by an interpreter.

“Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Library” refers to a collection of modules organized such that the functionality of all the modules may be included for use by software using references to the library in source code.

“Linker” refers to logic that inputs one or more object code files generated by a compiler or an assembler and combines them into a single executable, library, or other unified object code output. One implementation of a linker directs its output directly to machine memory as executable code (performing the function of a loader as well).

“Loader” refers to logic for loading programs and libraries. The loader is typically implemented by the operating system. A typical loader copies an executable into memory and prepares it for execution by performing certain transformations, such as on memory addresses.

“Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Machine language” refers to instructions in a form that is directly executable by a programmable device without further translation by a compiler, interpreter, or assembler. In digital devices, machine language instructions are typically sequences of ones and zeros.

“Module” refers to a computer code section having defined entry and exit points. Examples of modules are any software comprising an application program interface, drivers, libraries, functions, and subroutines.

“Object code” refers to the computer code output by a compiler or as an intermediate output of an interpreter. Object code often takes the form of machine language or an intermediate language such as register transfer language (RTL).

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Plug-in” refers to software that adds features to an existing computer program without rebuilding (e.g., changing or re-compiling) the computer program. Plug-ins are commonly used for example with Internet browser applications.

“Process” refers to software that is in the process of being executed on a device.

“Programmable device” refers to any logic (including hardware and software logic) who's operational behavior is configurable with instructions.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Software” refers to logic implemented as instructions for controlling a programmable device or component of a device (e.g., a programmable processor, controller). Software can be source code, object code, executable code, machine language code. Unless otherwise indicated by context, software shall be understood to mean the embodiment of said code in a machine memory or hardware component, including “firmware” and micro-code.

“Source code” refers to a high-level textual computer language that requires either interpretation or compilation in order to be executed by a device.

“Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’.

“Task” refers to one or more operations that a process performs.

### LISTING OF DRAWING ELEMENTS

100 resource exchange system
102 tracking and control system
104 intermediary resource provider
106 transaction log
108 procurement system
110 primary resource provider
112 primary resource provider
114 transport system
116 entity
118 banking resource system
120 items database
122 order database
124 tax authority
126 tax authority
128 tax estimator
130 tax resolver
132 resource rate/consumption controls
134 resource level controls
200 algorithm
202 block
204 block
206 block
208 block
210 block
212 block
214 block
216 block
218 block
300 algorithm
302 block
304 block
306 opening loop block
308 block
310 block
312 closing loop block
314 closing loop block
316 block
318 block
320 block
322 block
324 block
400 algorithm
402 block
404 block
406 block
408 block
410 block
412 block
414 block
500 resource control process
502 block
504 block
600 machine
602 instructions
604 processors
606 memory
608 I/O components
610 bus
612 processor
614 processor
616 main memory
618 static memory
620 storage unit
622 machine-readable medium
624 output components
626 input components
628 biometric components
630 motion components
632 environmental components
634 position components
636 communication components
638 network
640 devices
642 coupling
644 coupling
700 client server network configuration
702 network
704 mobile programmable device
706 operating system
708 app
710 app
712 computer
714 operating system
716 application
718 application
720 server
722 operating system
724 service
726 service
728 interpreter
730 driver
732 driver
734 driver
736 driver
738 file
740 file
742 plug-in

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A computing system for controlling consumption rates and consumption levels for a plurality of different categories of resources, the computing system comprising:
one or more processor; and
a memory storing instructions that, when executed by the one or more processor, configure the computing system to:
evaluate inputs from a combination of one or more resource providers and one or more banking resource providers by applying a one-to-one bulk allocation matching algorithm, a bulk allocation offsets algorithm, and a complex bulk allocation matching algorithm in a specific execution sequence; and
on condition that one of the bulk allocation algorithm outputs results that meet a configured accuracy constraint in the computing system:
terminate the execution sequence;
generate alerts on and controls of one or more of the consumption rates and consumption levels of the resources based on the results and further based on configured desired consumption rates and consumption levels of the resources; and
configure the computing system to utilize by default, on future inputs from the combination of resource providers, the one of the bulk allocation algorithms that output results that met the configured accuracy constraint.

2. The computing system of claim 1, wherein the one-to-one bulk allocation matching algorithm comprises:
ingesting and merging inputs from an intermediate resource provider, wherein the inputs comprise an items record and an orders record;
merging the inputs based on an order id;
scanning a transaction log for matches to bulk allocations in the orders record;
establishing correlations between groups of line items in the items record and bulk allocations in the orders record, wherein the correlations are established based on one or more of a banking transaction date, line item allocations, and vendor name;
on condition that the correlations meet a confidence threshold:
neutralizing the bulk allocations by one or both of deleting a record in the transaction log comprising the bulk allocation or altering the bulk allocation to zero in the transaction log;
inserting one or more new records in the transaction log for each line item correlated to the bulk allocation;
mapping attributes from the inputs to the new records in the transaction log utilizing one or a combination of column matching, multi-field formulas, and concatenated string mapping;
on condition that the correlations meet a confidence threshold:
skipping the processing of, and recording of, line items and bulk allocations in the inputs for the correlations that do not meet the confidence threshold; and
aggregating records in the transaction log into categorized total allocations;
wherein the generating of alerts on and controls of one or more of the consumption rates and consumption levels of the resources is based on comparisons of the categorized total allocations with the configured desired consumption rates and consumption levels of the resources.

3. The computing system of claim 1, wherein the bulk allocation offset matching algorithm comprises:
iterating through a plurality of order records received from an intermediary resource provider;
for each of the order records that is not a duplicate:
generating a plurality of transaction offset records in a transaction log each with an amount equal to a total of line item allocations in the order record but comprising an opposite polarity of line item allocations in the order record;
executing column mapping rules to categorize the transaction offset records into categories;
marking the transaction offset records to avoid a reimportation of identical line items from order records input from the intermediary resource provider in the future;
inserting a new record in the transaction log for each of the line item allocations in the order record; and
mapping fields from the data source to the new rows using one or more of simple column matching, multi-field calculated matching, and concatenated string mapping;
aggregating records in the transaction log into categorized total allocations; and
wherein the generating of alerts on and controls of one or more of the consumption rates and consumption levels of the resources is based on comparisons of the categorized total allocations with the configured desired consumption rates and consumption levels of the resources.

4. The computing system of claim 1, wherein the complex bulk allocation offset matching algorithm comprises:
ingesting and merging inputs from an intermediate resource provider, wherein the inputs comprise an items record and an orders record;
merging the inputs based on an order id;
for each order record:
scanning a transaction log to mark candidate order components based on one or more of a transaction date near a date of the order record, allocations less than a total allocation for the order record, and vendor description indications;
reducing the marked candidate order components by unmarking order records matched on prior iterations to generate a reduced set of order components for factorial analysis; and
performing factorial analysis on the reduced set of order components to identify combinations of the order components that meet a confidence threshold for matching the order record, based at least on the total allocation for the order record.

5. The computing system of claim 4, wherein the complex bulk allocation offset matching algorithm further comprises:
on condition that the confidence threshold is met:
neutralizing the bulk allocations by one or both of deleting a record comprising the bulk allocation or altering the bulk allocation to zero;
inserting one or more new records in the transaction log for each line item correlated to the bulk allocation;
mapping attributes from the inputs to the new records utilizing one or a combination of column matching, multi-field formulas, and concatenated string mapping;
skipping the processing of, and recording of, line items and bulk allocations in the inputs for the correlations that do not meet the confidence threshold;
aggregating records in the transaction log into categorized total allocations; and
wherein the generating of alerts on and controls of one or more of the consumption rates and consumption levels of the resources is based on comparisons of the categorized total allocations with the configured desired consumption rates and consumption levels of the resources.

6. A method for controlling consumption rates and consumption levels for a plurality of different categories of resources, the method comprising:
evaluating inputs from a combination of one or more resource providers and one or more banking resource providers by applying a one-to-one bulk allocation matching algorithm, a bulk allocation offsets algorithm, and a complex bulk allocation matching algorithm in a specific execution sequence; and
on condition that one of the bulk allocation algorithm outputs results that meet a configured accuracy constraint:
terminating the execution sequence;
generating alerts on and controls of one or more of the consumption rates and consumption levels of the resources based on the results and further based on configured desired consumption rates and consumption levels of the resources; and
configuring a computing system to utilize by default, on future inputs from the combination of resource providers, the one of the bulk allocation algorithms that output results that met the configured accuracy constraint.

7. The method of claim 6, wherein the one-to-one bulk allocation matching algorithm comprises:
ingesting and merging inputs from an intermediate resource provider, wherein the inputs comprise an items record and an orders record;
merging the inputs based on an order id;
scanning a transaction log for matches to bulk allocations in the orders record;
establishing correlations between groups of line items in the items record and bulk allocations in the orders record, wherein the correlations are established based on one or more of a banking transaction date, line item allocations, and vendor name;
on condition that the correlations meet a confidence threshold:
neutralizing the bulk allocations by one or both of deleting a record in the transaction log comprising the bulk allocation or altering the bulk allocation to zero in the transaction log;
inserting one or more new records in the transaction log for each line item correlated to the bulk allocation;
mapping attributes from the inputs to the new records in the transaction log utilizing one or a combination of column matching, multi-field formulas, and concatenated string mapping;
on condition that the correlations meet a confidence threshold:
skipping the processing of, and recording of, line items and bulk allocations in the inputs for the correlations that do not meet the confidence threshold.

8. The method of claim 7, further comprising:
aggregating records in the transaction log into categorized total allocations; and
wherein the generating of alerts on and controls of one or more of the consumption rates and consumption levels of the resources is based on comparisons of the categorized total allocations with the configured desired consumption rates and consumption levels of the resources.

9. The method of claim 6, wherein the bulk allocation offset matching algorithm comprises:
iterating through a plurality of order records received from an intermediary resource provider;
for each of the order records that is not a duplicate:
generating a plurality of transaction offset records in a transaction log each with an amount equal to a total of line item allocations in the order record but comprising an opposite polarity of line item allocations in the order record;
executing column mapping rules to categorize the transaction offset records into categories;
marking the transaction offset records to avoid a reimportation of identical line items from order records input from the intermediary resource provider in the future;
inserting a new record in the transaction log for each of the line item allocations in the order record; and
mapping fields from the data source to the new rows using one or more of simple column matching, multi-field calculated matching, and concatenated string mapping.

10. The method of claim 9, further comprising:
aggregating records in the transaction log into categorized total allocations; and
wherein the generating of alerts on and controls of one or more of the consumption rates and consumption levels of the resources is based on comparisons of the categorized total allocations with the configured desired consumption rates and consumption levels of the resources.

11. The computing system of claim 6, wherein the complex bulk allocation offset matching algorithm comprises:
ingesting and merging inputs from an intermediate resource provider, wherein the inputs comprise an items record and an orders record;
merging the inputs based on an order id;
for each order record:
scanning a transaction log to mark candidate order components based on one or more of a transaction date near a date of the order record, allocations less than a total allocation for the order record, and vendor description indications;
reducing the marked candidate order components by unmarking order records matched on prior iterations to generate a reduced set of order components for factorial analysis; and
performing factorial analysis on the reduced set of order components to identify combinations of the order components that meet a confidence threshold for matching the order record, based at least on the total allocation for the order record.

12. The computing system of claim 11, wherein the complex bulk allocation offset matching algorithm further comprises:
on condition that the confidence threshold is met:
neutralizing the bulk allocations by one or both of deleting a record comprising the bulk allocation or altering the bulk allocation to zero;
inserting one or more new records in the transaction log for each line item correlated to the bulk allocation;
mapping attributes from the inputs to the new records utilizing one or a combination of column matching, multi-field formulas, and concatenated string mapping;
skipping the processing of, and recording of, line items and bulk allocations in the inputs for the correlations that do not meet the confidence threshold.

13. The computing system of claim 12, further comprising:
aggregating records in the transaction log into categorized total allocations; and
wherein the generating of alerts on and controls of one or more of the consumption rates and consumption levels of the resources is based on comparisons of the categorized total allocations with the configured desired consumption rates and consumption levels of the resources.
